(19) United States
(12) Patent Application Publication
(10) Pub. No.: US 2009/0029031 A1
(43) Pub. Date: Jan. 29, 2009

(54) Methods for forming electrodes in phase change memory devices

(76) Inventor: Tyler Lowrey, Rochester Hills, MI (US)

Correspondence Address: Kevin L. Bray;OVONYX, INC., 2956 Waterview Drive, Rochester Hills, MI, 48309, US

(21) Appl. No.: 12/113,566

(22) Filed: May 1, 2008

Related U.S. Application Data
(63) Continuation-in-part of application No. 11/880,587, filed on Jul. 23, 2007.
Application No. 11/880,587 is a continuation-in-part of application No. 12/075,222, filed on Mar. 10, 2008.
Application No. 12/075,222 is a continuation-in-part of application No. 12/075,180, filed on Mar. 10, 2008.

(51) Int. Cl. B05D 5/12

(52) U.S. Cl. 427/58

(57) ABSTRACT

A method for forming electrode materials uniformly within openings having small dimensions, including sublithographic dimensions, or high aspect ratios. The method includes the steps of providing an insulator layer having an opening formed therein, forming a non-conformal conductive or semiresistive material over and within the opening, and mobilizing the conductive material to densify it within the opening. The method reduces the concentration of voids or defects in the conductive or semiresistive material relative to the as-deposited state. The mobilizing step may be accomplished by extrusion or thermal reflow and causes voids or defects to coalesce, collapse, percolate, or otherwise be removed from the as-deposited conductive or semiresistive material.

### CROSS-REFERENCE TO RELATED APPLICATIONS

This application is a continuation in part of U.S. patent application Ser. No. 11/880,587, entitled “Liquid Phase Deposition of Contacts in Programmable Resistance and Switching Devices” and filed on Jul. 23, 2007; and a continuation in part of U.S. patent application Ser. No. 12/075,222, entitled “Pressure Extrusion Method for Filling Features in the Fabrication of Electronic Devices and filed on Mar. 10, 2008; and a continuation in part of U.S. patent application Ser. No. 12/075,180, entitled “Temperature and Pressure Control Methods to Fill Features within Programmable Resistance and Switching Devices” and filed on Mar. 10, 2008; all of which disclosures are incorporated in their entirety herein.

### FIELD OF INVENTION

This invention relates generally to programmable resistance and switching devices having one or more electrodes. More particularly, this invention relates to methods for forming electrodes for programmable resistance and switching device structures. Most particularly, this invention relates to formation of electrodes in confined regions to facilitate miniaturization of programmable resistance and switching devices.

### BACKGROUND OF THE INVENTION

Programmable resistance materials and fast switching materials are promising active materials for next-generation electronic storage, computing and signal transfer devices. A programmable resistance material possesses two or more states that differ in electrical resistance. The material can be programmed back and forth between the states by providing energy to induce an internal chemical, electronic, or physical transformation of the material that manifests itself as a change in resistance of the material. The different resistance states can be used to store or process data.

Fast switching materials are capable of being switched between a relatively resistive state (a quiescent low conduction state) and a relatively conductive state. Application of an energy signal, typically an electrical energy signal, induces the change from the relatively resistive state to the relatively conductive state. The relatively conductive state persists for so long as the energy signal is applied. Once the energy signal is removed, the switching material relaxes back to its quiescent state. Devices that incorporate switching materials are useful as voltage clamping devices, surge suppression devices, signal routing devices, and solid state memory access devices.

Phase change materials are a promising class of programmable resistance materials. A phase change material is a material that is capable of undergoing a transformation, preferably reversible, between two or more distinct structural states. In a common embodiment, a phase change material is reversibly transformable between a crystalline state and an amorphous state. In the crystalline state, the phase change material has lower resistivity; while in the amorphous state, it has higher resistivity. The distinct structural states of a phase change material may be distinguished on the basis of, for example, crystal structure, atomic arrangement, order or disorder, fractional crystallinity, relative proportions of two or more different structural states, a physical (e.g. electrical, optical, magnetic, mechanical) or chemical property etc. Reversibility of the transformations between structural states permits reuse of the material over multiple cycles of operation.

Typically, a programmable resistance material or switching device is formed by placing an active material, such as a phase change material, between two electrodes. Operation of the device is effected by providing an electrical signal between the two electrodes and across the active material. Programmable resistance materials may be used as the active material of a memory device. Write operations in a memory device, which may also be referred to herein as programming operations, apply electric pulses to the memory device. Read operations, which measure the resistance or threshold voltage of the memory device, are performed by providing current or voltage signals across the two electrodes. The transformation between the relative resistive state and relatively conductive state of a switching material is similarly induced by providing a current or voltage signal between two electrodes in contact with the switching material. One of the significant practical challenges that programmable resistance memory and switching devices face is to reduce the contact area of one or more electrodes contacting the active material. By reducing the contact area, the energy required to program a memory device or switch a switching device can be reduced and more efficient devices can be achieved.

Fabrication of semiconductor devices such as logic and memory devices typically includes a number of processes that may be used to form various features and multiple levels or layers of semiconductor devices on a surface of a semiconductor wafer or another appropriate substrate. Physical vapor deposition (PVD), chemical vapor deposition (CVD), and other deposition processes involving the reaction, decomposition or coating of gaseous, liquid, or solid precursors may be used in the formation of semiconductor devices. Lithography is a patterning process in the formation of semiconductor devices that is commonly used to define small-scale features and often sets a limit on the goal of device miniaturization. Additional semiconductor fabrication processes include chemical-mechanical polishing (CMP), etching, annealing, ion implantation, plating, and cleaning. In normal fabrication, an array containing a large number of semiconductor devices is formed on a semiconductor wafer.

In semiconductor device fabrication, it is desirable to reduce the length scale or feature size of devices as much as possible so that a greater number of devices can be formed per unit substrate area. As the feature size of devices is minimized, however, processing of the devices becomes more difficult. Small scale features become more difficult to define as the lithographic limit of resolution is reached and features that are defined become more difficult to process.

A common step in processing involves depositing a layer and forming an opening in it. Openings such as channels, trenches, holes, vias, pores or depressions in layers are commonly employed to permit interconnections between devices or layers of a structure. Typically, the opening is formed by lithography, then etching, and is subsequently filled with another material. As the dimension or length scale of an opening decreases upon miniaturization, it becomes increasingly difficult to fill the opening with another material without compromising performance or durability.

Techniques such as physical vapor deposition (PVD) or sputtering fail to provide dense or complete filling of openings when the dimensions of the opening are reduced below a critical size. Instead of providing a dense, uniform filling, these techniques increasingly incompletely fill openings as the feature size of the opening decreases. As the feature size decreases, there is a tendency for the packing density of the material formed in the opening to vary in the depth or lateral dimensions of the opening and as a result, the layer deposited within the opening may include voids, vacancies, gaps, pores, keyholes, or other non-uniform regions. Imperfections in the filling of openings become especially pronounced as the aspect ratio (ratio of the depth dimension to the lateral dimension of the feature) of the opening increases. Deep, narrow channels, for example, are more difficult to fill uniformly than channels that are shallow and wide. With deep, narrow features, sputtering and other physical deposition techniques are oftentimes unable to deliver sufficient material to the bottom of the feature. Instead, a layer of material is formed over or only near the top of the feature and the lower part of the feature is blocked and remains largely unfilled. Lack of structural uniformity in the filling of openings compromises performance because: (1) variations in device characteristics occur across an array due to differences in the degree or nature of filling non-uniformities from device-to-device and (2) less than optimal performance is achieved for each device due to the defective nature of the material within the opening.

Conformality of deposition is another processing difficulty that becomes exacerbated as feature size decreases. Fabrication of semiconductor devices generally involves forming a stack of layers, where the individual layers may differ in dimensions (lateral to or normal to the substrate) and compositions. The process of fabricating a semiconductor device generally involves sequential deposition of one layer upon a lower (previously formed) layer. Optimal device performance requires conformality of later-formed layers with earlier-formed layers. Each layer in a stack must conform to the shape and contours of the layer in the stack upon which it is formed. Smooth and uniform coverage is desired.

In addition to difficulties with achieving uniform filling, openings also present complications for achieving conformal deposition that become more pronounced as size of the opening decreases. The boundary or perimeter of an opening is frequently defined by an edge, step, or other relatively discontinuous feature. The shape of an opening is generally defined by a sidewall or perimeter boundary and a lower surface or bottom boundary. A trench opening, for example, is defined by generally vertical sidewalls and a bottom surface that is generally parallel to the substrate.

When fabricating semiconductor devices, it is often necessary to first form a layer with an opening and to subsequently deposit another layer over this layer. Conformality requires that the subsequent layer faithfully conform to the shape and texture of the underlying layer having the opening. The subsequent layer must deposit uniformly over both the portion of the underlying layer in which the opening has not been formed as well as over the opening itself. Conformality over the opening requires uniform coverage of the edges or steps that form the boundary of the opening. Achieving conformality over discontinuous features becomes increasingly difficult as the feature size of the opening decreases or the aspect ratio of the opening increases.

Fabrication of programmable resistance and switching devices often includes a step of forming an opening in a dielectric layer and filling the opening with a conductive material to form an electrical contact. Miniaturization of programmable resistance and switching devices requires methods for reducing the dimensions of the electrical contacts. Contacts with small dimensions are beneficial because the energy required to operate programmable resistance and switching devices decreases with decreasing contact size. Accordingly, it is desirable to develop techniques for forming and filling openings with small dimensions without suffering from the imperfections in filling and conformality associated with standard prior art techniques such as sputtering or physical vapor deposition. Ideally, the techniques would enable the fabrication of electrical contacts for programmable resistance and switching devices having dimensions near, at or below the lithographic limit.

Referring to the drawings, FIG. 1 depicts a representative structure of a phase change material device that illustrates the nature of imperfections that may form in an electrical contact having a sublithographic dimension when the contact is deposited via sputtering or physical vapor deposition. A conductive layer 106 is formed over a substrate 102. An insulative layer 110 having an opening formed therein is then formed over conductive layer 106. Lower electrical contact 128 is formed in the opening of insulative layer 110 using a physical vapor deposition process and CMP planarization. A layer of phase change material 114 is then deposited onto lower electrical contact 128 and a top electrode layer 116 is deposited over the phase change layer 114. Lower electrical contact 128 includes imperfections in the form of internal voids 120 and non-conformal region 112. The imperfections detract from device performance.

To improve the quality of electrical contacts in high aspect ratio devices, new methods are needed. The methods must provide more uniform filling of the openings in which the electrical contacts are formed as well as greater conformality with underlying and surrounding layers than the prevailing methods.

### SUMMARY OF THE INVENTION

The instant invention provides electronic devices having logic, memory, switching, or processing functionality based on programmable resistance materials, switching materials or other active materials and methods of fabricating same.

In accordance with one embodiment of the instant invention, a programmable resistance or switching device includes a substrate with a plurality of stacked layers including a bottom conductive layer, an insulator layer having an opening formed therein that exposes the bottom conductive layer, a lower electrode plug or liner formed in the opening by deposition and planarization, an active material deposited over the electrode plug and over the insulative layer, and a top electrode layer deposited over the active material.

The active material may be a programmable resistance material, switching material or other electronic material. Representative active materials include chalcogenide materials, phase-change materials, and threshold switching materials.

In one embodiment, one or more electrodes include a conductive or semi-resistive material where at least a portion of the electrode occupies or fills the opening. The electrode may be a plug electrode, a sidewall electrode (e.g. ring or liner), a rectilinear electrode, or a planar electrode and may also function as a resistive heater. The electrode may be a single layer or composite electrode that includes multiple layers or regions. The electrode may be in electrical contact or communication with wordlines or bitlines to permit transfer or receipt of electrical signals from external circuits.

The opening may be round, elliptical, bent, rectilinear or other circumferential shape. In one embodiment, the opening is a circular hole that is filled or lined with an electrode material. In another embodiment, the opening is a trench that is filled or lined with an electrode material. The opening has an aspect ratio that ranges between 0.25 and 5 and may include dimensions at or below the lithographic limit.

The methods for forming the electrode material include extrusion and reflow. The electrode formation methods are designed to selectively and conformally fill or occupy the opening with an electrode material. The methods reduce structural irregularities of the electrode material within the opening and promote more uniform and higher density filling of openings by reducing the volume fraction of voids and structural defects.

For a better understanding of the instant invention, together with other and further illustrative objects thereof, reference is made to the following description, taken in conjunction with the accompanying drawings and claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a schematic depiction of a conventional two-terminal electronic device having defects or voids in an electrical contact material contained in an opening of a surrounding layer.

FIG. 2 illustrates a two-terminal electronic device with an electrical contact material that conformally and uniformly fills an opening of a surrounding layer.

FIG. 3 illustrates a cross-sectional view of the electronic device shown in FIG. 2 at an intermediate stage of fabrication that includes a substrate, a lower conductive layer, and an insulator layer.

FIG. 4 is a schematic depiction of the electronic device shown in FIG. 3 having an opening within the insulative layer.

FIG. 5 is a schematic depiction of the electronic device shown in FIG. 4 further including an electrode material with voids or defects formed over the opening.

FIG. 6 illustrates the initial application of force in an extrusion process to the electronic device shown in FIG. 5.

FIG. 7 illustrates the electronic device shown in FIG. 6 at an intermediate stage of an extrusion process.

FIG. 8 illustrates the electronic device shown in FIG. 6 at a late stage of an extrusion process.

FIG. 9 illustrates the electronic device shown in FIG. 8 after planarization.

FIG. 10 is a schematic depiction of a pore cell device design and a filler plug cell device design.

FIG. 11 is a schematic depiction of a recessed filler plug cell device and a microtrench device.

FIG. 12 is a schematic depiction of two confined cell devices.

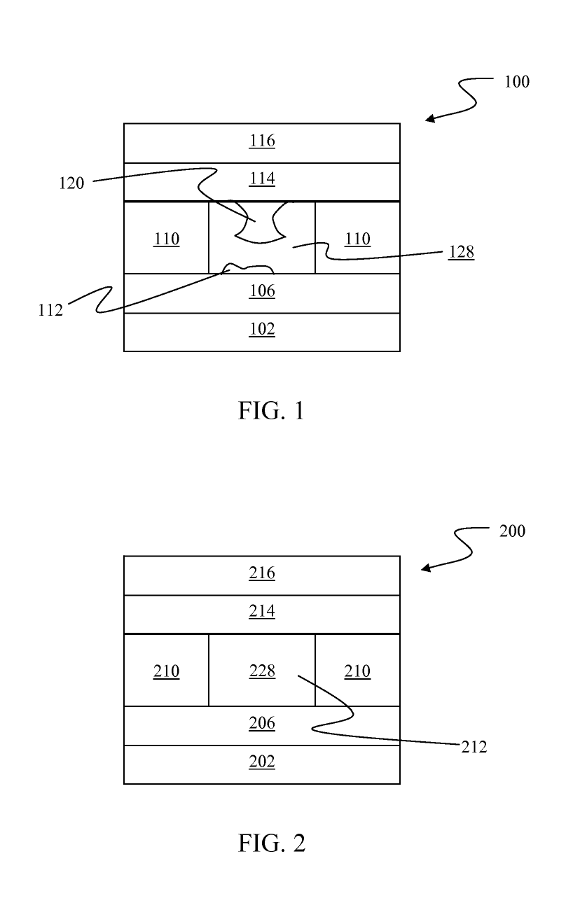

### DETAILED DESCRIPTION OF ILLUSTRATED EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The instant invention relates generally to electronic devices that include two or more electrodes in contact or electrical communication with an active material. As used herein, active material refers generally to an electrically stimulable material such as a programmable resistance material used for memory, programmable logic, or other applications; other memory material; or electrical switching material. A programmable resistance material is a material having two or more states that are distinguishable on the basis of electrical resistance. The two or more states may be structural states, chemical states, electrical states, optical states, magnetic states, or a combination thereof. A programmable resistance material is transformable (“programmable”) between any pair of states by supplying an appropriate amount of energy to the material. The supplied energy may be referred to as a “programming energy”. When transformed (“programmed”) to a particular state, the programmable resistance material remains in that state until additional energy is supplied to the material. The different states of a programmable resistance material are stable in the absence of external energy and persist for an appreciable amount of time upon removal of the source of programming energy. Programmable resistance materials include phase-change materials, chalcogenide materials, pnictide materials, and other multi-resistance state materials.

Phase change materials include materials that are transformable between two or more crystallographically-distinct structural states. The states may differ in crystal structure, unit cell geometry, unit cell dimensions, degree of disorder, particle size, grain size, or composition. Chalcogenide materials are materials that include an element from Column VI of the periodic table (e.g. S, Se, and/or Te) as a significant component along with one or more modifying elements from Columns III (e.g. B, Al, Ga, In), IV (e.g. Si, Ge, Sn), and/or V (e.g. Sb, Bi, P, As) of the periodic table. Pnictide materials are materials that include an element from Column V of the periodic table as a significant component along with one or more modifying elements from Columns III, IV, or VI of the periodic table. Many chalcogenide and pnictide materials are phase-change materials that are transformable between and among a plurality of crystalline, partially crystalline, and amorphous states. Other multi-resistance state materials include metal-insulator-metal structures with thin film insulators, or conductive oxide materials such as a family of CuO materials used in RRAM devices. Programmable resistance materials may serve as the active material in memory devices, including non-volatile memory devices. Representative programmable resistance materials in accordance with the instant invention are described in U.S. Pat. Nos. 5,543,737; 5,694,146; 6,087,674; 6,967,344; 6,969,867; 7,020,006; and references cited therein; all of which disclosures are incorporated by reference herein. These references also describe the basic operational characteristics of chalcogenide phase-change materials.

Electrical switching materials are materials that are switchable between two states that differ in electrical conductivity. The two states range in conductivity from the relatively resistive (e.g. comparable to a dielectric) to the relatively conductive (e.g. comparable to a metal). Electrical switching materials generally have a quiescent or relaxed state, usually a relatively more resistive state, in which they exist in the absence of electrical energy. When electrical energy is applied, the switching material transforms to the more conductive state and persists in that state transitorily for so long as it is subjected to a critical amount of energy from an external source. When the external energy decreases below the critical level, the switching material relaxes back to its quiescent state. Switching materials include OTS (Ovonic Threshold Switch) materials, negative differential resistance materials, and metal-insulator-metal structures. Certain chalcogenide and pnictide compositions exhibit electrical switching. Illustrative switching materials include those described in U.S. Pat. Nos. 6,967,344 and 6,969,867 incorporated by reference hereinabove.

FIG. 2 illustrates a typical structure of an electronic device 200 having two electrodes. The electrodes may also be referred to herein as contacts or electrical contacts. The main part of the structure of device 200 is formed as stacked layers on a substrate 202. The substrate 202 may be a silicon substrate or a substrate comprising other semiconductor materials. Substrate 202 may include a doped semiconductor material as well as access devices, power devices, or other electronic circuitry. The stacked layers include a lower conductive layer 206, a lower electrical contact 228 within opening 212 of an insulator layer 210, an active layer 214, and an upper electrode layer 216. Electrical contact 228 is a restricted geometry electrode formed within opening 212 that is in electrical contact with lower conductive layer 206. Lower conductive layer 206 permits electrical communication between lower contact 228 and external circuitry. In one embodiment, lower conductive layer 206 may correspond to a grid line, such as a word line or a bit line of an array structure. Although upper electrode 216 is depicted as a blanket contact in FIG. 2, it may also be a restricted geometry electrode and may also be interconnected to other conductive layers such as a word line or a bit line of an array of devices.

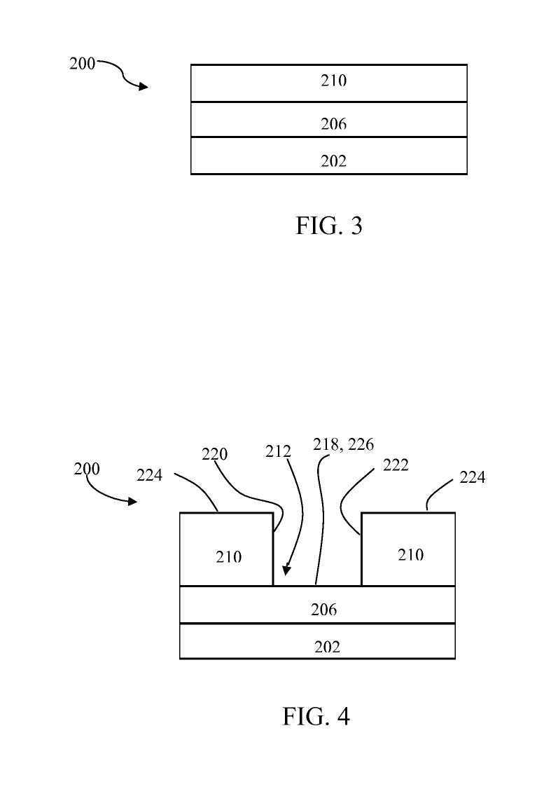

FIG. 3 shows a cross sectional view of the lower portion of device structure 200 at an intermediate stage of fabrication. The lower conductive layer 206 is formed on substrate 202 and insulator layer 210 is formed on lower conductive layer 206. Lower conductive layer 206 may be a metal, metal alloy or metal compound. Representative metals for lower conductive layer 206 include aluminum (Al), copper (Cu), tungsten (W), molybdenum (Mo), niobium (Nb), tantalum (Ta), rhenium (Re) or alloys thereof. The resistivity of lower conductive layer 206 may be controlled by varying the level of elements such as nitrogen or silicon incorporated in a metal or metal alloy. Compound materials that may be used to form conductive layer 206 include metal nitrides, metal chelates, organometallic compounds, or combinations thereof. Representative examples include TiN, TiSiN TiAlN, TiW, MoN, MoAlN, and MoSiN.

In one embodiment, lower conductive layer 206 is formed in a sputtering process and its resistivity may be adjusted by changing the nitrogen-to-metal ratio present in the growth environment. A greater nitrogen concentration will result in an increase in the resistivity. Alternatively, the resistivity of the lower conductive layer 206 may be adjusted by changing the silicon-to-metal ratio. A greater silicon concentration will result in an increase in the resistivity. Reactive sputtering of metals in a nitrogen or oxygen atmosphere permits control over the resistivity of lower conductive layer 206.

Insulator layer 210 provides electrical and thermal isolation of lower contact 228. Insulator layer 210 is generally an oxide, nitride or other dielectric material. Representative materials for insulator layer 210 include silicon oxides (e.g. SiO₂, SiOₓ), and silicon nitrides (e.g. Si₃N₄, SiNₓ). Insulator layer 210 may be formed using chemical or physical vapor deposition processes, including plasma-assisted processes.

Opening 212 in insulator layer 210 is formed and exposes a portion 218 of lower conductive layer 206 as shown in FIG. 4. Opening 212 has a predefined depth, width, and shape. Representative openings include depressions, pores, vias, trenches, holes, and channels. The openings may be formed by patterning and selectively removing portions of insulator layer 210. Standard photolithography, mask and etch, and reactive ion etching techniques may be used to form opening 212. Multiple openings 212 may be formed across a substrate to permit fabrication of an array of devices.

Insulator layer 210 and exposed portion 218 of lower conductive layer 206 cooperate to define the dimensions of the opening 212. Opening 212 includes sidewall surface 220, sidewall surface 222, and bottom 226 (which corresponds to the top surface of exposed portion 218 of lower conductive layer 206). The shape or cross-section of opening 212 may be controlled through the patterning process. The cross-sectional shape of opening 212 may be round (e.g. circular or elliptical), curved, linear, rectilinear (e.g. trench), polygonal, or bent. Accordingly, lower contact 228 may be round or non-round in shape and may form an enclosed or non-enclosed (e.g. arc, line, segment) structure. The full range of patterns and shapes of masks known in the art are within the scope of the instant invention. In the embodiment of FIG. 4, sidewall surfaces 220 and 222 may correspond to different sidewalls (e.g. the left and right sidewalls of a trench) or different portions of the same sidewall (e.g. opposing portions of a circular hole).

In an embodiment of the invention, the width or lateral dimension of opening 212 is at the lithographic limit. The lithographic limit is a feature size or physical dimension limit imposed by photolithographic processing capabilities. The lithographic limit is normally attributable to a limit on the ability to reduce the wavelength of the light source used to pattern or segment features during processing. According to the current technology roadmap, the feature size limit for flash technology is 65 nm (NOR)/57 nm (NAND). As processing techniques improve, the feature size limit will decrease in the future to further the goal of miniaturization. The projected feature size limit is 45 nm (NOR)/40 nm (NAND) in 2010 and 32 nm (NOR)/28 nm (NAND) in 2013. The methods described herein for forming contacts will scale and maintain their efficacy as the feature size limit decreases in the future.

In another embodiment, the width or lateral dimension of the opening 212 is sublithographic. In one embodiment, a sublithographic dimension is a dimension that is smaller than the minimum dimension achievable through optical UV lithography. An opening with sublithographic dimensions may be formed, for example, by first forming an opening with at or near a minimum lithographic dimension and then depositing a sidewall layer disposed within the opening to narrow its dimensions. An opening with sublithographic dimensions may also be formed, in another example, by forming a dielectric material on an underlying substrate, etching the dielectric material to expose a sidewall surface, forming a sacrificial layer having a thickness below the lithographic limit on the sidewall surface, anisotropically etching the sacrificial layer to remove the horizontal portions thereof, forming a dielectric layer over the remaining vertical portion of the sacrificial layer, planarizing to expose the top surface of the vertical sacrificial layer, and removing the vertical sacrificial layer to form an opening. In this latter method, the dimensions of the opening are controlled by the thickness of the deposited sacrificial layer and this thickness can readily be made to be well below the lithographic limit using many deposition techniques (e.g. chemical vapor deposition or atomic layer deposition).

In one embodiment, the width or lateral dimension of opening 212 is less than 1000 Å. In another embodiment, the width or lateral dimension of opening 212 is less than 600 Å. In yet another embodiment, the width or lateral dimension of opening 212 is less than 300 Å. The width or lateral dimension of the opening 212 is generally the physical dimension of the opening in a direction parallel to the substrate 202. In FIG. 4, for example, the width or lateral dimension is the distance between sidewall 220 and sidewall 222. When the shape of the opening is round, the lateral dimension may be the diameter or the equivalent thereof of the opening.

The aspect ratio of opening 212 may be defined as the ratio of the height or normal dimension of the opening to the width or lateral dimension of the opening. The height or normal dimension of the opening 212 is generally the physical dimension of the opening perpendicular to the substrate 202. In FIG. 4, for example, the height or normal dimension of the opening 212 corresponds to the thickness of insulative layer 210. In one embodiment of the instant invention, height or normal dimension of the opening 212 is at least 100 Å. In another embodiment of the instant invention, height or normal dimension of the opening 212 is at least 500 Å. In yet another embodiment of the instant invention, height or normal dimension of the opening 212 is at least 1000 Å. In one embodiment of the instant invention, the aspect ratio of the opening 212 is at least 0.5:1. In another embodiment of the instant invention, the aspect ratio of the opening 212 is at least 2:1. In yet another embodiment of the instant invention, the aspect ratio of the opening 212 is at least 4:1.

Opening 212 is filled in accordance with the instant invention with an electrical contact material 228 to form device structure 200 (see FIG. 2). Electrical contact 228 may be a single homogeneous layer of a conductive or semiresistive material or a combination of two or more layers differing in composition and/or resistivity. Electrical contact 228 is generally a metal, metal alloy, or metal compound. As used herein, the terms “electrode material”, “electrode layer”, “electrical contact material”, “electrical contact layer”, or “electrical contact” generally refer to materials or layers that are conductive or semiresistive. Examples of suitable electrical contact materials include refractory metals (e.g. Ni, Co, Cr, Pt, Ti, Ta, W, Mo, Nb), alloys of refractory metals (e.g. Ptlr), nitrides of refractory metals (e.g. MoN, TiN, TiAlN, TiSiN, TiCN, TiSiC, TaN, TaCN, TaSiN, WN, WSiN, NbN), carbon, nitrogenated carbon, and dual layer metal and metal nitride combinations (e.g. Ti/TiN). In one embodiment, a dual layer structure is formed within an opening in which a first layer formed over the sidewall of the opening acts as a diffusion barrier layer and a second layer is formed within the first layer. The diffusion barrier layer acts to prevent atomic migration or exchange of mass between the inner second layer and the material of the layer in which the opening is formed. Metal nitrides (e.g. TiN) often serve as barriers to prevent the diffusion or migration of metals (e.g. W).

As indicated hereinabove, incorporation of nitrogen in metal or metal alloy compositions permits control over the resistivity of electrode materials. Resistivity control is desirable for active materials that operate at least partially via a thermal mechanism. In the case of phase-change materials, for example, formation of an amorphous phase state from a crystalline phase state requires local temperatures that are sufficient to melt the material. A resistive contact 228 creates thermal energy locally due to Joule heating as current passes through the device and provides an efficient source of programming energy.

By forming electrical contact 228 in a reduced dimensionality opening, it is possible to reduce the area of electrical communication between electrical contact 228 and active layer 214. The reduced area of electrical communication is beneficial because it permits operation of the device at lower currents. The reduced area of electrical contact 228, for example, more effectively channels external programming currents received by lower conductive layer 206. Confined electrical contact 228 delivers the operating current to a more controlled and spatially-limited region of active material 214. The effective volume of active material 214 transformed by the operating current is reduced and the overall energy required to operate the device is decreased as current loss and heat loss to portions of active layer 214 not essential to programming are minimized. Once the opening 212 is filled and planarized, a chalcogenide or other active material layer 214 is deposited over the upper surfaces of insulative layer 210 and upper surface of deposited layer 228, and a top electrode layer 216 is formed on top of active material layer 214.

In order to realize the benefits of a reduced area of electrical communication, it is necessary that electrical contact 228 fills or occupies opening 212 in a uniform fashion, without voids or gaps, and that electrical contact 228 adheres as conformally as possible to the exposed top surface 218 of lower conductive layer 206 and sidewall surfaces 220 and 222 (see FIG. 4). Voids, gaps, non-conformalities and other defects, whether internal to electrical contact 228 or at an interface of electrical contact 228 with a surrounding material, can lead to undesirable contact resistances at the top and bottom surfaces of electrical contact 228 and represent features that can vary over time or with cycling to impair device endurance or reliability.

As discussed hereinabove, physical vapor deposition (e.g. sputtering) is a widely used method for forming electrical contacts. The method is advantageous because of its simplicity and versatility over a wide range of electrode compositions, but suffers from the tendency to form layers having voids and non-conformalities. These tendencies become more pronounced as the aspect ratio of the feature into which deposition occurs increases and are primarily attributable to the line-of-sight nature of deposition. Better techniques are needed to realize the benefits of reduced dimensionality electrodes.

In co-pending U.S. patent application Ser. No. 11/880,587 (“'587 application”), liquid phase methods for filling openings with conductive materials were described. Methods discussed in the '587 application include dip coating, electroplating, electroless plating, and selective deposition. These methods were shown to provide more uniform filling of openings and greater conformality of the fill material with surrounding layers in the structure. In this application, further methods of filling or disposing conductive or semi-resistive materials within reduced dimensionality or high aspect ratio features such as opening 212 are described. The methods include extrusion and reflow.

Extrusion is a method whereby a force is applied during or after deposition to density or compact a deposited film in an effort to more completely and more uniformly fill an opening. In co-pending U.S. patent application Ser. No. 12/075,180 ('180 application), an extrusion method based on the application of mechanical force to a programmable resistance or switching material was described. In the method, a programmable resistance or switching material was formed over an opening and forced into the opening by mechanical force. The material as deposited incompletely filled the opening and the application of force resulted in a densification and packing of the material within the opening to eliminate voids and provide better uniformity. Mechanical force can be applied by pressing a rigid surface onto the deposited material to cause it to mobilize and flow to fill a feature. In one example, a ram with an optically flat surface contacted an active material formed over a feature using a physical vapor deposition process. The deposited active material included internal voids within the opening and gaps at boundaries with surrounding layers. Pressing the ram on the surface of the deposited material led to a reduction in the volume fraction of voids and a greater packing density of the opening. In addition, more consistent filling of openings across an array of devices resulted.

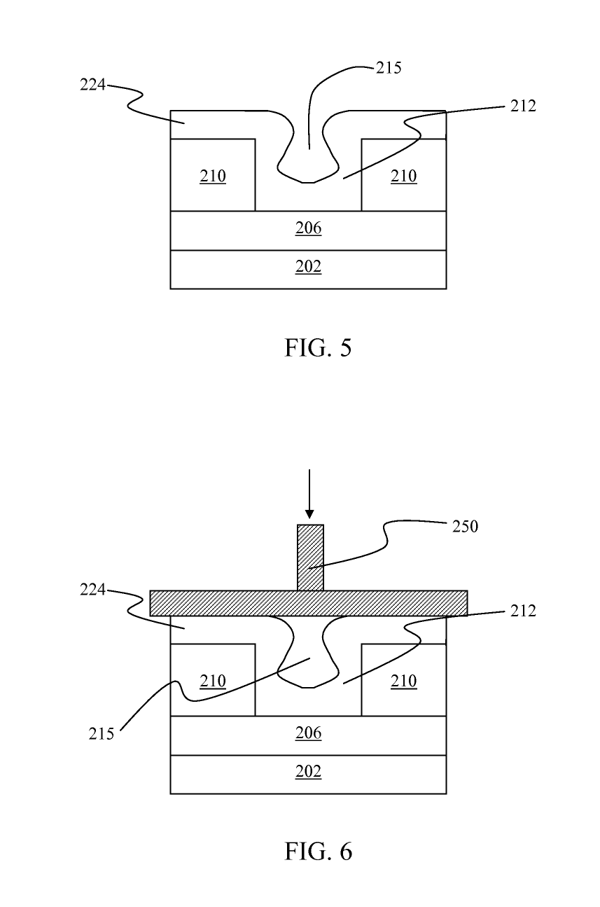

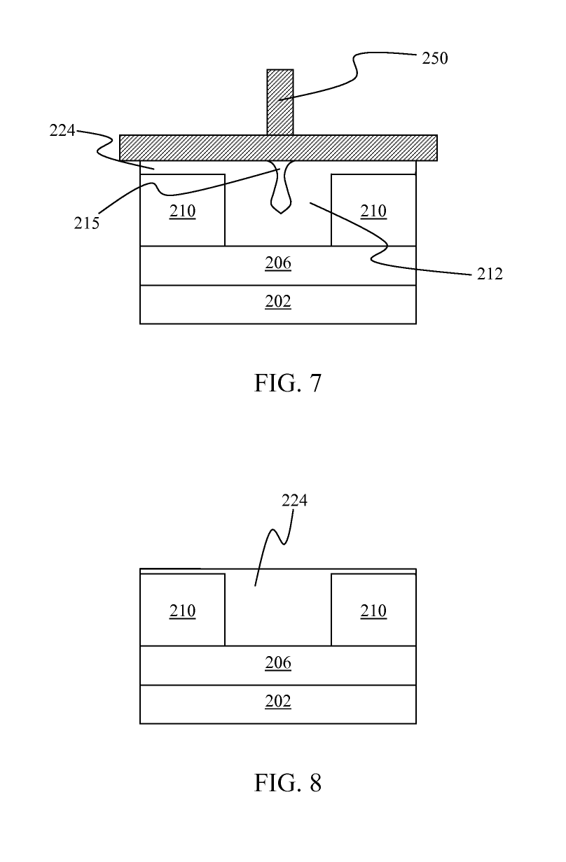

In an embodiment of this invention, lower contact 228 is formed by an extrusion process. FIG. 5 shows the structure of FIG. 4 after deposition of conductive layer 224. Conductive layer 224 is formed within opening 212 and on the top surface of insulator layer 210. Conductive layer 224 includes illustrative void 215. In FIG. 6, ram 250 is placed on the upper surface of conductive layer 224 and pressed to cause extrusion and collapse of void 215 to form the structure shown in FIG. 7. The application of force has densified conductive layer 224 and reduced the volume fraction of void 215. Void 215 can be substantially eliminated by continuing or increasing the force applied to ram 250. When densification to the desired degree is achieved, ram 250 is removed to obtain the structure shown in FIG. 8. The excess portion of conductive layer 224 can be removed by planarizing the structure using chemical-mechanical polishing or etching to complete formation of lower contact 228 (FIG. 9).

Extrusion may also be induced by elevating the ambient pressure of the environment of the as-deposited conductive material. In co-pending U.S. patent application Ser. No. 12/075,222 ('222 application), a high pressure extrusion method was described in which an increase in the pressure of the ambient gases surrounding the as-deposited conductive material was shown to cause extrusion of an active electronic material to achieve a more uniform filling of reduced dimensionality features and better conformality with surrounding layers. In an embodiment of the instant invention, elevation of the ambient pressure of a conductive material deposited within and over an opening is used to densify a conductive material to achieve better filling of an opening. Instead of applying mechanical force by pressing a rigid surface such as ram 250 on the surface of conductive material 224 as shown in FIG. 7, the elevated pressure of a surrounding ambient gas can provide the impetus to mobilize an as-deposited conductive material to induce densification and collapse of voids and other internal structural irregularities.

Reflow is a thermal method for mobilizing a conductive material to eliminate voids within features and to improve contact or conformality with surrounding layers. In the co-pending '180 application, reflow was demonstrated to improve the filling density and conformality of programmable resistance and switching materials within restricted dimensionality features of electronic device structures. In an embodiment of the instant invention, reflow is used to eliminate voids and non-conformalities of electrode materials within openings. In reflow, an as-deposited electrode material is heated to a temperature sufficient to soften the material to induce flow. As the material flows, voids (such as void 215 shown in FIG. 5) collapse or percolate to the surface. As a result, the density of the electrode material within the opening increases and a more uniform contact having greater conformality with surrounding layers is achieved. The elimination of voids and densification obtained from a reflow process is comparable to the effects depicted for mechanical force illustrated in FIGS. 6-9 and permits conversion of an electrical contact material having voids or defects to an electrical contact material that more densely and more uniformly fills an opening.

By heating conductive material 224 shown in FIG. 5 to a softening point, the viscosity of the material decreases and the material flows from its as-deposited state. The motion of flow may be driven, for example, by gravity or surface tension and the net result is a coalescence or densification of conductive material 224 within opening 212. Heating need only occur to a temperature sufficient to mobilize conductive material 224, but may occur at higher temperatures as well. Further increases in temperature beyond the softening point (e.g. to temperatures at or near the melting point) may facilitate or hasten the reflow process. A molten conductive material, for example, flows more readily than a softened conductive material. Higher temperatures, however, may also facilitate evaporation, vapor pressure material loss, phase-separation, or reactivity of the conductive material, so these factors must be balanced against the efficacy of thermally-induced reflow at a particular temperature for a particular composition of conductive material. In a further embodiment of the instant invention, reflow may be combined with mechanical or high pressure extrusion to remove voids and/or improve conformality of conductive materials deposited in low dimensionality features of electronic devices.

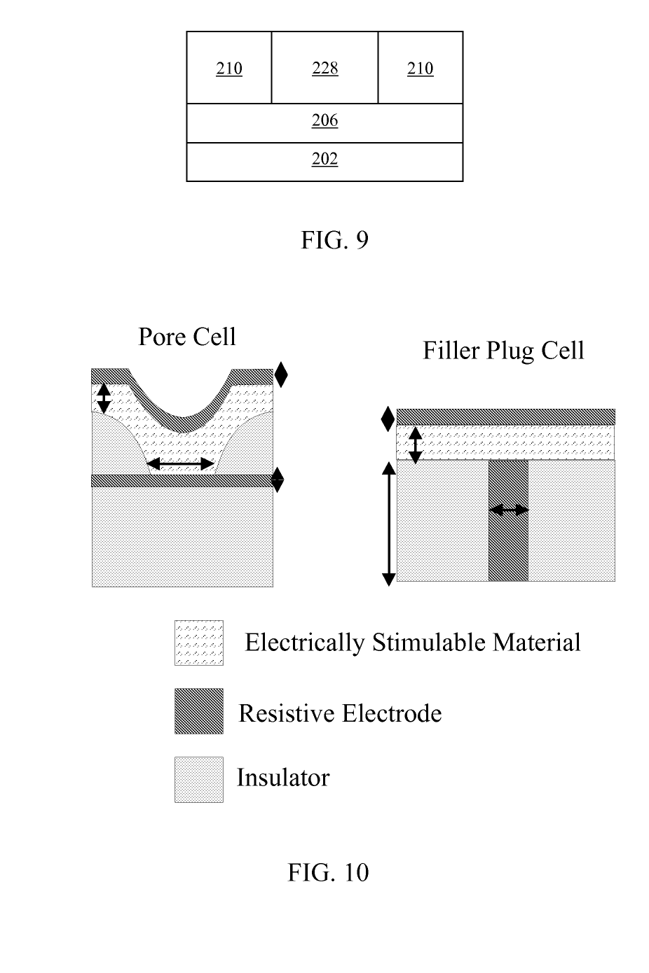

The instant extrusion and reflow methods for forming electrodes within openings can be applied to any device structure having a low dimensional or high aspect ratio opening. Representative device structures are illustrated in FIGS. 10-12, which show the central portion of devices that include an electrically stimulable material, resistive electrodes in electrical communication with the electrically stimulable material, and a surrounding insulator material. The electrically stimulable material, resistive electrodes, and insulator regions of the structure are separately indicated by distinctive shading as shown in each of FIGS. 10-12. The electrically stimulable material is a material that is responsive to an electrical current, voltage or field and includes programmable resistance materials, phase-change materials, chalcogenide materials, and switching materials as described hereinabove.

FIG. 10 shows devices based on the pore cell and filler plug cell designs. In the pore cell, the electrically stimulable material tapers to a narrowed area of contact with the lower resistive electrode and may include an irregularly shaped top surface upon which an upper resistive electrode must be formed. In the pore cell example shown in FIG. 10, the upper resistive electrode is formed over a depression of the top surface of the electrically stimulable material. A depression is an embodiment of an opening herein and in a pore cell, the shape, dimensions and aspect ratio of the depression may vary and come within the regime in which conventional electrode deposition techniques form electrodes with voids or other defects as described hereinabove. Application of the instant extrusion or reflow techniques permits formation of upper resistive electrodes having greater structural uniformity within depressions. Similarly, the lower resistive electrode of the filler plug cell is typically formed within a high aspect ratio opening of a surrounding dielectric material and can be formed with greater uniformity and fewer defects using the instant extrusion and reflow methods.

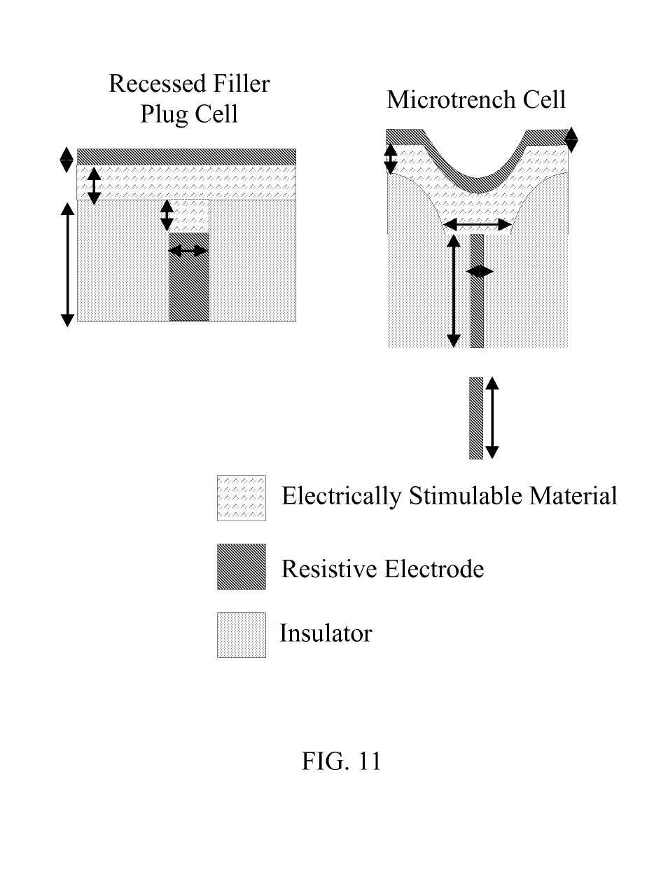

FIG. 11 shows the recessed filler plug cell design and the microtrench cell design. The recessed filler plug cell is a variation of the filler plug cell in which a portion of the electrically stimulable material is recessed into the high aspect ratio opening in which the lower electrode is formed. As described in the co-pending '222 and '180 applications, extrusion and reflow may also be used to fill high aspect ratio or openings with small dimensions with an electrically stimulable material. The instant invention includes an embodiment in which a resistive material is first formed by a non-conformal technique a high aspect ratio or small dimension opening and subjected to an extrusion or reflow process to improve the quality of the fill, where an electrically stimulable material is subsequently formed over the resistive material and could possibly itself be subjected to an extrusion or reflow process. A lower electrode, for example, may be formed by PVD, subjected to extrusion or reflow, and a programmable resistance or switching material may next be formed by PVD and subjected to extrusion or reflow. In a related embodiment, a composite resistive electrode that includes layers of two or more materials or adjacent regions differing in resistivity may be formed via a sequential process in which a first resistive electrode material is formed and subjected to extrusion or reflow and a second resistive electrode material is then formed and subjected to extrusion or reflow. If the second resistive electrode material is adjacent to the electrically stimulable material and has a higher resistivity than the first resistive electrode material, the composite electrode more effectively localizes current-induced thermal energy in close proximity to the electrically stimulable material and provides more efficient operation. By way of example, a Ti layer may be formed by a non-conformal technique (such as sputtering), subjected to extrusion or reflow and a TiN layer may subsequently be formed over the Ti layer by a non-conformal technique (such as reactive sputtering in the presence of a nitrogen-containing gas (e.g. N₂ or NH₃) and subjected to extrusion or reflow. The microtrench cell is a variation of the pore cell design in which the lower resistive electrode is reduced in one or more lateral dimensions in order to minimize the lower contact area. Formation of either or both of the upper or lower resistive electrodes of the microtrench cell may include an extrusion or reflow step following deposition of the electrode material.

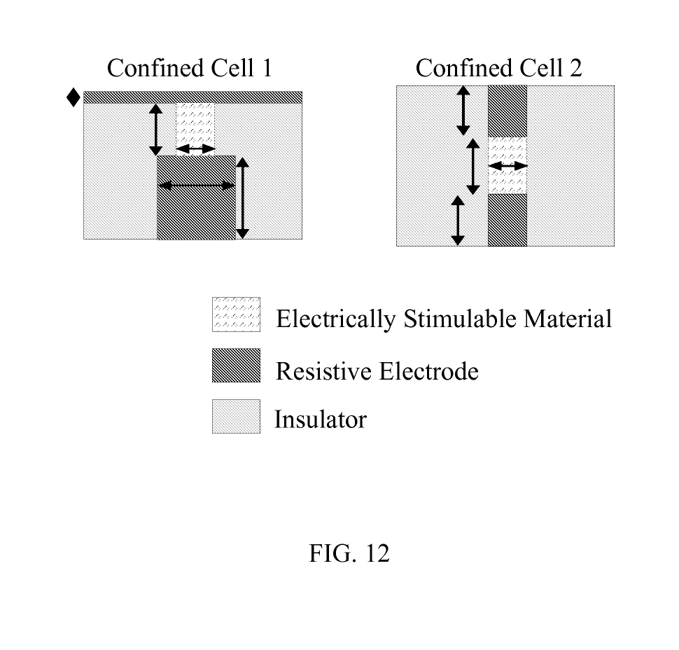

FIG. 12 shows two variations of the confined cell design. In the confined cell, the objective is to confine the volume of the electrically stimulable material to the smallest dimensions that permit resolution of the operable electrical states. Smaller dimensions require less energy for programming and external confinement by a surrounding insulator having a low thermal conductivity further improves efficiency by minimizing heat losses away from the region of programming. In other embodiments of the confined cell, the electrodes are also restricted in size to lower the current needed to resistively heat the electrode (Joule heating) to a temperature sufficient for programming. In a phase-change material, for example, programming to the reset state requires production of temperatures sufficient to melt the phase-change material. By confining the phase-change material and/or electrodes to smaller dimensions, the current density associated with a particular level of current increases and higher temperatures can be created at lower current levels. The instant methods of extrusion and reflow can be used to form confined volumes of either or both of the electrically stimulable material or resistive electrodes in the confined cell structure. Either or both of the lower or upper electrodes can be formed in a confined geometry using the methods of the instant invention. Extrusion and reflow provide a particular advantage when forming an upper electrode (e.g. upper electrode of confined cell 2 in FIG. 12) because these methods provide uniform and conformal electrode materials at lower temperatures than alternative conformal techniques. Temperature is an important consideration because the upper electrode is formed after formation of the electrically stimulable material and many such materials decompose, volatilize or otherwise degrade when subjected to elevated temperatures. Extrusion can be performed at room temperature or at elevated temperatures below those that damage the electrically stimulable material. Similarly, the temperature of reflow can be maintained below temperatures that adversely affect the electrically stimulable material. In one embodiment, extrusion or reflow of an electrode material occurs at a temperature below the melting point of the electrically stimulable material. In another embodiment, extrusion or reflow of an electrode material occurs at a temperature at least 100° C. below the melting temperature of the electrically stimulable material.

The instant extrusion and reflow methods operate generally to reduce the volume fraction of voids, defects and other structural irregularities within an opening and to increase the volume fraction of electrode material within the opening. In one embodiment, the instant extrusion and reflow methods reduce the volume fraction of voids present in the structure of an electrode material in an opening by at least 50% relative to the as-deposited state. In another embodiment, the instant extrusion and reflow methods reduce the volume fraction of voids present in the structure of an electrode material in an opening by at least 75% relative to the as-deposited state. In still another embodiment, the instant extrusion and reflow methods reduce the volume fraction of voids present in the structure of an electrode material in an opening by at least 90% relative to the as-deposited state. The reduction in void volume fraction is compensated by an increase in the volume fraction of an electrode material in the opening. The indicated void volume reductions are achievable for openings having aspect ratios of at least 0.25:1 up to aspect ratios of at least 5:1.

The disclosure and discussion set forth herein is illustrative and not intended to limit the practice of the instant invention. While there have been described what are believed to be the preferred embodiments of the instant invention, those skilled in the art will recognize that other and further changes and modifications may be made thereto without departing from the spirit of the invention, and it is intended to claim all such changes and modifications that fall within the full scope of the invention. It is the following claims, including all equivalents, in combination with the foregoing disclosure and knowledge commonly available to persons of skill in the art, which define the scope of the instant invention.

We claim:

1. A method of forming an electronic device comprising:
providing an insulative layer having an opening defined therein, said opening having a sidewall;
forming a first electrode layer over said opening; and
mobilizing said first electrode layer.

2. The method of claim 1, wherein the depth of said opening is equal to the thickness of said insulative layer.

3. The method of claim 2, wherein said insulating layer is formed over a second electrode layer, said opening exposing a top surface of said second electrode layer.

4. The method of claim 3, wherein said first electrode layer contacts said exposed portion of said second electrode layer.

5. The method of claim 4, wherein said mobilization of said first electrode layer improves the conformality of said first electrode layer with said second electrode layer.

6. The method of claim 1, wherein said first electrode layer partially occupies said opening.

7. The method of claim 6, wherein said mobilizing increases the amount of said first electrode layer in said opening.

8. The method of claim 1, wherein said first electrode layer non-conformally contacts said insulative layer and said sidewall of said opening.

9. The method of claim 8, wherein said first electrode layer includes one or more voids, at least one of said one or more voids occupying said opening.

10. The method of claim 9, wherein said mobilizing reduces the volume of said one or more voids occupying said opening.

11. The method of claim 10, wherein said mobilizing reduces said volume of said one or more voids occupying said opening by at least 50%.

12. The method of claim 10, wherein said mobilizing reduces said volume of said one or more voids occupying said opening by at least 75%.

13. The method of claim 10, wherein said mobilizing reduces said volume of said one or more voids occupying said opening by at least 90%.

14. The method of claim 10, wherein said mobilizing causes said first electrode layer to fill said opening.

15. The method of claim 10, wherein said opening has an aspect ratio of at least 0.25:1.

16. The method of claim 10, wherein said opening has an aspect ratio of at least 1:1.

17. The method of claim 10, wherein said opening has an aspect ratio of at least 3:1.

18. The method of claim 10, wherein a dimension of said opening is at the lithographic limit.

19. The method of claim 10, wherein a dimension of said opening is sublithographic.

20. The method of claim 10, wherein a dimension of said opening is less than 1000 Å.

21. The method of claim 10, wherein a dimension of said opening is less than 500 Å.

22. The method of claim 10, wherein a dimension of said opening is less than 300 Å.

23. The method of claim 1, wherein said mobilizing includes the application of mechanical force to said first electrode layer.

24. The method of claim 23, wherein said mechanical force is applied by pressing a flat surface against said first electrode layer.

25. The method of claim 24, wherein said flat surface is heated.

26. The method of claim 1, wherein said mobilizing includes heating said first electrode layer.

27. The method of claim 1, further comprising forming an electrically stimulable material over said first electrode layer.

28. The method of claim 27, wherein said electrically stimulable material is selected from the group consisting of non-volatile memory materials, programmable resistance materials, electronic switching materials, chalcogenide materials, phase-change materials, and pnictide materials.

29. The method of claim 27, wherein said electrically stimulable material comprises Te and Sb.

30. The method of claim 27, further comprising mobilizing said electrically stimulable material.

31. The method of claim 30, wherein said mobilization of said electrically stimulable material increases the volume fraction of said electrically stimulable material in said opening.

32. The method of claim 30, wherein said mobilization of said electrically stimulable material improves the conformality of said electrically stimulable material with said first electrode layer.

33. The method of claim 30, further comprising forming a second electrode layer over said electrically stimulable material.

34. The method of claim 33, further comprising mobilizing said second electrode layer.

35. The method of claim 34, wherein said mobilization of said second electrode layer occurs at a temperature below the volatilization temperature of said electrically stimulable material.

36. The method of claim 1, further comprising forming a second electrode layer over said first electrode layer.

37. The method of claim 36, further comprising mobilizing said second electrode layer.

38. The method of claim 37, wherein said mobilization of said second electrode layer increases the volume fraction of said second electrode layer in said opening.

39. The method of claim 1, wherein said first electrode layer is formed by physical vapor deposition.
